(19) United States
(12) Patent Application Publication
(10) Pub. No.: US 2024/0017740 A1
(43) Pub. Date: Jan. 18, 2024

(54) TECHNIQUES TO CONTROL AN ENGINE FOR AUTONOMOUS DRIVING OPERATIONS

(71) Applicant: TUSIMPLE, INC., San Diego, CA (US)

(72) Inventors: Jinghui SONG, Tucson, AZ (US); Haimo BI, Tucson, AZ (US); Xiaoling HAN, San Diego, CA (US)

(21) Appl. No.: 18/352,204

(22) Filed: Jul. 13, 2023

Related U.S. Application Data
(60) Provisional application No. 63/368,720, filed on Jul. 18, 2022.

(51) Int. Cl. B60W 60/00; B60W 10/08; B60W 10/18; B60W 10/20

(52) U.S. Cl. CPC B60W 60/001; B60W 10/08; B60W 10/18; B60W 10/20; B60W 2300/145; B60W 2710/083

(57) ABSTRACT

The technology enables an in-vehicle control computer located in an autonomous vehicle to control an output of a propulsion apparatus based on an estimate of the electrical load of one or more devices on or in the autonomous vehicle. An example method of autonomous driving operation includes determining, at a first time, by a computer located in the vehicle, a second energy or power consumption value of a plurality of devices that are expected to operate at a second time later than the first time, where the second energy or power consumption value is a different than a first energy or power consumption value of the plurality of devices at the first time; and sending, by the computer, the second energy or power consumption value to control an engine or a motor located in the vehicle.

### CROSS-REFERENCE TO RELATED APPLICATIONS

This document claims priority to and the benefit of U.S. Provisional Application No. 63/368,720, filed on Jul. 18, 2022. The aforementioned application is incorporated herein by reference in its entirety.

### TECHNICAL FIELD

This document relates to systems, methods, and apparatus to control one or more parameters of an engine, such as torque, for autonomous driving systems.

### BACKGROUND

Self-driving or autonomous vehicles can be autonomously controlled to navigate along a path to a destination. Autonomous driving generally requires sensors and processing systems that perceive the environment surrounding an autonomous vehicle and make decisions based on that perception to facilitate safe and reliable operation of the autonomous vehicle.

### SUMMARY

This patent document describes systems, apparatus, and methods to control an output of a propulsion apparatus (e.g., engine, motor, etc.,) in an autonomous vehicle based on estimate of the electrical load (or estimated power consumption) of one or more devices on or in the autonomous vehicle.

An example method of controlling a vehicle comprises determining, at a first time, by a computer located in the vehicle, a second energy or power consumption value of a plurality of devices that are expected to operate at a second time later than the first time, where the second energy or power consumption value is a different than a first energy or power consumption value of the plurality of devices at the first time, where the second energy or power consumption value is an estimate of an electrical load of the plurality of devices at the second time, and where the plurality of devices are located on or in the vehicle; and sending, by the computer, the second energy or power consumption value to control an engine or a motor located in the vehicle, where the sending the second energy or power consumption value causes the engine or the motor to generate an output that is based on the second energy or power consumption value, and where an electrical output generated by an alternator that is mechanically coupled to the engine or the motor is approximately same as the second energy or power consumption value.

In some embodiments, the second energy or power consumption value of the plurality of devices is determined based on the computer receiving an indication that indicates that the vehicle is expected to perform autonomous driving related operations. In some embodiments, the autonomous driving related operations include sending instructions to one or more devices in the vehicle, where the instructions cause the one or more devices to steer or apply brakes or select a gear for the vehicle. In some embodiments, an energy or power consumption value of a device of the plurality of devices at the first time is zero kilowatt-hour (kWh), and the first energy or power consumption value includes the energy or power consumption value added to one or more additional energy or power consumption values of one or more additional energy or power consumption values.

In some embodiments, the electrical output is approximately the same as the second energy or power consumption value in response to the electrical output being within a pre-determined percentage of the second energy or power consumption value. In some embodiments, the determining the second energy or power consumption value of the plurality of devices includes determining at the first time a first estimate of a first electrical load of a device that is expected to be turned on at the second time, where the plurality of devices include the device. In some embodiments, the first energy or power consumption value is lower than the second energy or power consumption value. In some embodiments, the second energy or power consumption value is not based on another output generated by the engine or the motor at the first time.

In some embodiments, the first energy or power consumption value and the second energy or power consumption value indicate values having units of energy of kilo-watt hour (kWh). In some embodiments, after the sending the second energy or power consumption value, the operations further comprise: sending a third energy or power consumption value that is less than the second energy or power consumption value to control the engine or the motor, where the sending the third energy or power consumption value causes the engine or the motor to generate another output that is based on the third energy or power consumption value, and where another electrical output generated by the alternator is approximately same as the third energy or power consumption value. In some embodiments, the second energy or power consumption value of the plurality of devices is determined based on a total electrical load of at least some of the plurality of devices for autonomous driving related operations. In some embodiments, the estimate of the electrical load of the plurality of devices at the second time includes a total electrical load of the plurality of devices at the second time.

In some embodiments, a system comprises a computer located in a vehicle, the computer comprising a processor configured to implement a method, comprising: determine, at a first time, a second energy or power consumption value of a plurality of devices that are expected to operate at a second time later than the first time, where the second energy or power consumption value is a different than a first energy or power consumption value of the plurality of devices at the first time, where the second energy or power consumption value is an estimate of an electrical load of the plurality of devices at the second time, and where the plurality of devices are located on or in the vehicle; and send, by the computer, the second energy or power consumption value to control an engine or a motor located in the vehicle, where the send the second energy or power consumption value causes the engine or the motor to generate an output that is based on the second energy or power consumption value, and where an electrical output generated by an alternator that is mechanically coupled to the engine or the motor is approximately same as the second energy or power consumption value.

In some embodiments, the system further comprises a device that is communicably coupled to the computer and a propulsion apparatus, where the device includes a microcontroller that is configured to: receives the second energy or power consumption value from the computer; convert the second energy or power consumption value to a first value; and send the first value to the engine or the motor. In some embodiments, the microcontroller of the device is further configured to: receive, from the engine or the motor, a measured value that is a measurement of the output, where the output includes an output power or an output torque or an output revolutions per minute (RPM); determine an error value as a difference between the first value and the measured value; and send a combined value to the engine or the motor, where the combined value is a function of the error value and the first value that is related to the second energy or power consumption value. In some embodiments, the second energy or power consumption value is a pre-determined estimate of the electrical load of the plurality of devices. In some embodiments, the first energy or power consumption value is higher than the second energy or power consumption value. In some embodiments, the plurality of devices include one or more cameras and one or more LiDARs. In some embodiments, the vehicle is a tractor unit of a semi-trailer truck.

In yet another exemplary aspect, the above-described method is embodied in a non-transitory computer readable storage medium. The non-transitory computer readable storage medium includes code that when executed by a processor, causes the processor to perform the methods described in this patent document.

In yet another exemplary embodiment, a device that is configured or operable to perform the above-described methods is disclosed. In yet another exemplary embodiment, a system comprises a computer located in a vehicle, the computer comprises a processor configured to implement the above-described methods is disclosed.

The above and other aspects and their implementations are described in greater detail in the drawings, the descriptions, and the claims.

### BRIEF DESCRIPTION OF THE DRAWINGS

FIG. 1 illustrates a block diagram of an example vehicle ecosystem to manage electrical load of an autonomous vehicle by controlling a propulsion apparatus of the autonomous vehicle.

FIG. 2 shows a block diagram of an example scenario where an in-vehicle control computer sends instruction to control an output generated by a propulsion apparatus of a vehicle based on an estimate of the electrical load of one or more devices that are expected to operate on or in the vehicle.

FIG. 3 shows an example flowchart for controlling a propulsion apparatus of a vehicle based on an estimate of the electrical load of one or more devices on or in the vehicle.

### DETAILED DESCRIPTION

In a vehicle, an increase or decrease of electrical power of one or more devices in the vehicle can cause the vehicle's propulsion apparatus (e.g., engine, motor, etc.,) to reactively increase or decrease a torque or power output or revolutions per minute (RPM) of the propulsion apparatus. For example, when an air conditioning (AC) system is turned on in a vehicle, the total amount of electrical power consumed by the vehicle increases, which causes the vehicle's propulsion apparatus to reactively increase its power output (e.g., torque or energy). However, when a conventional propulsion apparatus is implemented in an autonomous vehicle, it can lead to technical problems. For example, in some scenarios, devices in the autonomous vehicle can consume a significant amount of electrical power to facilitate autonomous driving operation in the autonomous vehicle. In such scenarios, the conventional propulsion apparatus can cause a large increase or decrease in its power output which can cause a jerk in the autonomous vehicle. This can happen because both the drivetrain (e.g., output shaft from engine to transmission), and the alternator rely on the same power source which can include the engine so that if the alternator suddenly draws a lot of power and if the engine does not respond to the increased load fast enough, then the output torque to the drivetrain will suddenly reduce which will cause the truck to experience a sudden jerk. To address at least this technical problem, this patent document describes techniques that can proactively control the torque or power output or RPM of the propulsion apparatus to meet the electrical power needs of one or more devices in the autonomous vehicle.

This patent document first describes in Section I an example vehicle ecosystem for controlling a propulsion apparatus of an autonomous vehicle, and then describes in Section II example techniques to control a propulsion apparatus of an autonomous vehicle.

I. Example Ecosystem for Controlling a Propulsion Apparatus in a Vehicle

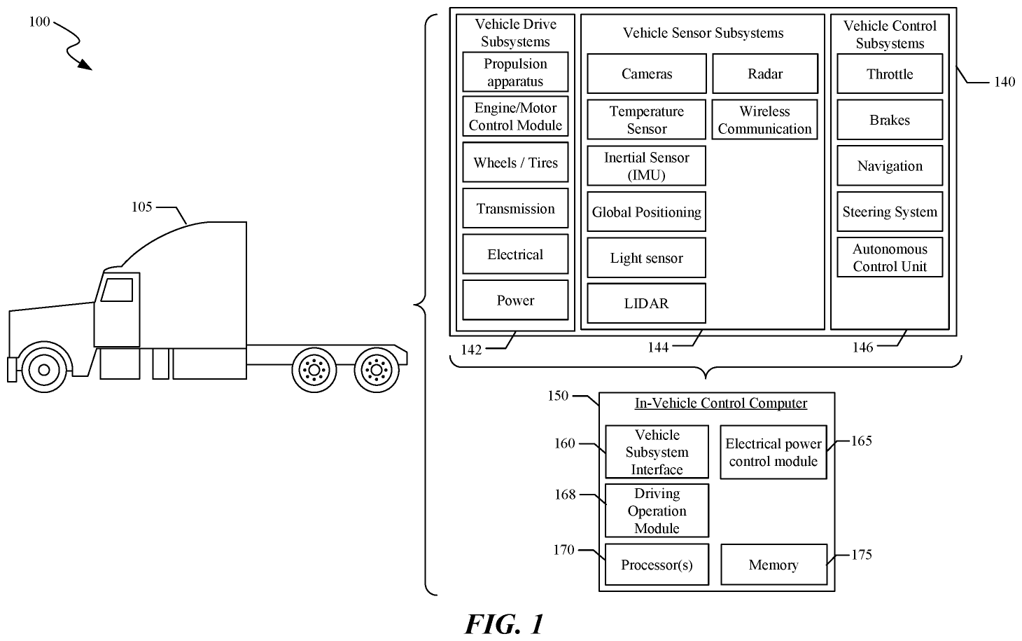

FIG. 1 illustrates a block diagram of an example vehicle ecosystem to manage electrical load of an autonomous vehicle by controlling a propulsion apparatus of the autonomous vehicle. The system 100 includes an autonomous vehicle 105, such as a tractor unit of a semi-trailer truck. The autonomous vehicle 105 may include a plurality of vehicle subsystems 140 and an in-vehicle control computer 150. The plurality of vehicle subsystems 140 can include, for example, vehicle drive subsystems 142, vehicle sensor subsystems 144, and vehicle control subsystems 146. FIG. 1 shows several devices or systems being associated with the autonomous vehicle 105. In some embodiments, additional devices or systems may be added to the autonomous vehicle 105, and in some embodiments, some of the devices or systems show in FIG. 1 may be removed from the autonomous vehicle 105.

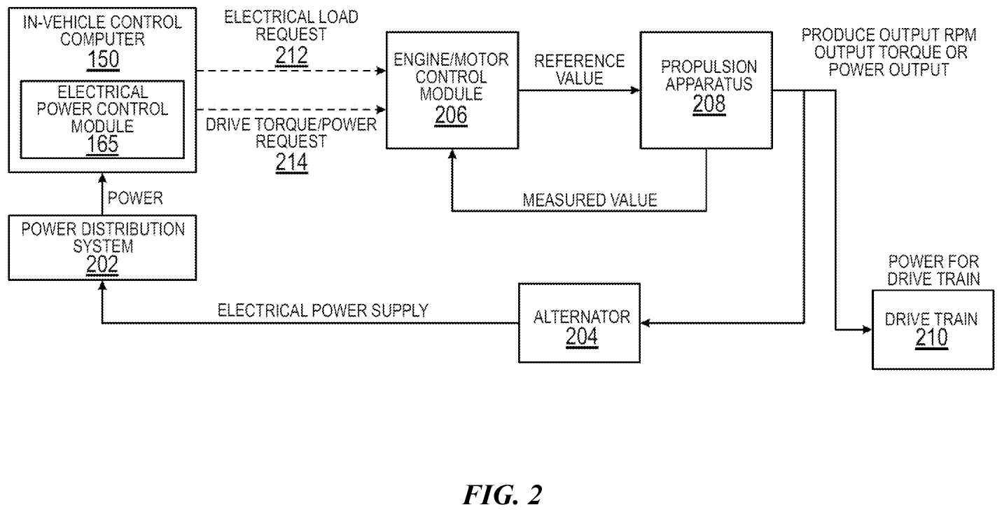

A propulsion apparatus, engine/motor control module, wheels and tires, a transmission, an electrical subsystem, and/or a power subsystem may be included in the vehicle drive subsystems 142. A drivetrain may include the wheels and tires and the transmission. The propulsion apparatus of the autonomous truck may be an internal combustion engine (or gas-powered engine), a fuel-cell powered electric engine, a battery powered electric engine/motor, a hybrid engine, or another type of engine capable of actuating the wheels on which the autonomous vehicle 105 (also referred to as vehicle 105 or truck 105) moves. The propulsion apparatus of the autonomous vehicle 105 can have multiple engines to drive its wheels. For example, the vehicle drive subsystems 142 can include two or more electrically driven motors. The engine/motor control module (also shown as 206 in FIGS. 2A-2B) located in the autonomous vehicle 105 may be a hardware device that may include a microcontroller, where the microcontroller can receive information from the electrical power control module 165 of the in-vehicle control computer 150 and can send information to the propulsion apparatus to increase/decrease torque or power output or revolutions per minute (RPM) generated by the propulsion apparatus to manage electrical load of the autonomous vehicle 105. The microcontroller can perform the operations described in this patent document for the engine/motor control module.

The transmission of the vehicle 105 may include a continuous variable transmission or a set number of gears that translate power created by the engine of the vehicle 105 into a force that drives the wheels of the vehicle 105. The vehicle drive subsystems 142 may include an electrical system (e.g., a power distribution system (shown as 202 in FIG. 2)) that monitors and controls the distribution of electrical current to components within the vehicle drive subsystems 142 (and/or within the vehicle subsystems 140), including pumps, fans, actuators, in-vehicle control computer 150 and/or sensors (e.g., cameras, LiDARs, RADARs, etc.,). The power subsystem of the vehicle drive subsystems 142 may include components which regulate a power source of the vehicle 105.

Vehicle sensor subsystems 144 can include sensors which are used to support general operation of the autonomous truck 105. The sensors for general operation of the autonomous vehicle may include, for example, one or more cameras, a temperature sensor, an inertial sensor, a global positioning system (GPS) receiver, a light sensor, a LiDAR system, a radar system, and/or a wireless communications system.

The vehicle control subsystems 146 may include various elements, devices, or systems including, e.g., a throttle, a brake unit, a navigation unit, a steering system, and an autonomous control unit. The vehicle control subsystems 146 may be configured to control operation of the autonomous vehicle, or truck, 105 as a whole and operation of its various components. The throttle may be coupled to an accelerator pedal so that a position of the accelerator pedal can correspond to an amount of fuel or air that can enter the internal combustion engine. The accelerator pedal may include a position sensor that can sense a position of the accelerator pedal. The position sensor can output position values that indicate the positions of the accelerator pedal (e.g., indicating the amounts by which the accelerator pedal is depressed or that the accelerator pedal is undepressed).

The brake unit can include any combination of mechanisms configured to decelerate the autonomous vehicle 105. The brake unit can use friction to slow the wheels of the vehicle in a standard manner. The brake unit may include an anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically based on, e.g., traffic or road conditions, while, e.g., the autonomous vehicle 105 is in operation. In some embodiments, the navigation unit may be configured to incorporate data from a GPS device and one or more predetermined maps so as to determine the driving path for the autonomous vehicle 105. The steering system may represent any combination of mechanisms that may be operable to adjust the heading of the autonomous vehicle 105 in an autonomous mode or in a driver-controlled mode of the vehicle operation.

The autonomous control unit may include a control system (e.g., a computer or controller comprising a processor) configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some example embodiments, the autonomous control unit may be configured to incorporate data from the GPS device, the radar, the LiDAR, the cameras, and/or other vehicle sensors and subsystems to determine the driving path or trajectory for the autonomous vehicle 105.

An in-vehicle control computer 150, which may be referred to as a vehicle control unit or VCU, can include, for example, any one or more of: a vehicle subsystem interface 160, an electrical power control module 165, a driving operation module 168, one or more processors 170, and/or a memory 175. This in-vehicle control computer 150 may control many, if not all, of the operations of the autonomous truck 105 in response to information from the various vehicle subsystems 140. The memory 175 may contain processing instructions (e.g., program logic) executable by the processor(s) 170 to perform various methods and/or functions of the autonomous vehicle 105, including those described in this patent document. For instance, the data processor 170 executes the operations associated with vehicle subsystem interface 160, electrical power control module 165, and/or driving operation module 168. The in-vehicle control computer 150 can control one or more elements, devices, or systems in the vehicle drive subsystems 142, vehicle sensor subsystems 144, and/or vehicle control subsystems 146. For example, the driving operation module 168 in the in-vehicle control computer 150 may operate the autonomous vehicle 105 in an autonomous mode in which the driving operation module 168 can send instructions to various elements or devices or systems in the autonomous vehicle 105 to enable the autonomous vehicle to drive along a determined trajectory. For example, the driving operation module 168 can send instructions to the steering system to steer the autonomous vehicle 105 along a trajectory, and/or the driving operation module 168 can send instructions to apply an amount of brake force to the brakes to slow down or stop the autonomous vehicle 105.

The electrical power control module 165 can be also configured to communicate and/or interact via a vehicle subsystem interface 160 with the systems of the autonomous vehicle including, e.g., the engine/motor control module. The electrical power control module 165 can, for example, receive data from or send data and/or commands or instructions to an engine (e.g., via the engine/motor control module as further explained in FIG. 2) to control the torque or power output of the propulsion apparatus of the autonomous vehicle. The vehicle subsystem interface 160 may include a software interface (e.g., application programming interface (API)) through which the electrical power control module 165 can send instructions to control the engine (e.g., via the engine/motor control module). For example, the vehicle subsystem interface 160 may include an engine software interface (e.g., a software interface provided by engine manufacturer) through which the vehicle engine control can indicate a value (e.g., revolutions per minute (RPM) or power output or torque value) to the propulsion apparatus. The vehicle subsystem interface 160 may also include a software interface to control or select the gear of the transmission.

The memory 175 may include instructions to transmit data to, receive data from, interact with, or control one or more of the vehicle drive subsystems 142, vehicle sensor subsystems 144, or vehicle control subsystems 146. The in-vehicle control computer (VCU) 150 may control the operation of the autonomous vehicle 105 based on inputs received by the VCU from various vehicle subsystems (e.g., the vehicle drive subsystems 142, the vehicle sensor subsystems 144, and the vehicle control subsystems 146). The VCU 150 may, for example, send information (e.g., commands, instructions or data) to the vehicle control subsystems 146 to direct or control functions, operations or behavior of the autonomous vehicle 105 including, e.g., its trajectory, velocity, and signaling behaviors. The vehicle control subsystems 146 may receive a course of action to be taken from one or more modules of the VCU 150 and may, in turn, relay instructions to other subsystems to execute the course of action.

II. Techniques to Control a Propulsion Apparatus in an Autonomous Vehicle

Section II of this patent document describes techniques for an in-vehicle control computer 150 located in an autonomous vehicle 105 to control a revolutions per minute (RPM) or power output or torque generated by a propulsion apparatus of the autonomous vehicle 105. As further explained below, the electrical power control module 165 in the in-vehicle control computer 150 can use a software interface (e.g., API) stored in the in-vehicle control computer 150 to communicate with the propulsion apparatus 208 (e.g., via an engine/motor control module 206)

FIG. 2 shows a block diagram of an example scenario where an in-vehicle control computer 150 sends instruction to control an output (e.g., torque, power, RPM) generated by a propulsion apparatus 208 of a vehicle based on an estimate of the electrical load of one or more devices that are expected to operate on or in the vehicle. On the bottom left of FIG. 2, a power distribution system 202 sends electrical power to an in-vehicle control computer 150. The power distribution system may include one or more devices (e.g., power distribution unit(s) (PDU)) that can control and/or route electrical power received from an alternator 204 to one or more devices (e.g., VCU 150, sensors (e.g., cameras, LiDARs, and/or RADARs), GPS device) on the vehicle.

In FIG. 2, the in-vehicle control computer 150 includes an electrical power control module 165 that can determine at a first time an estimate of electrical load of one or more devices that are expected to operate at a second time later in time than the first time on or in the vehicle. At the second time, the one or more devices are expected to operate at a second energy/power consumption value, where the second energy/power consumption value is higher or lower than a first second energy/power consumption value of the one or more devices at the first time. For example, a current electrical load (or first energy/power consumption) of a device that is turned off may be zero kilowatt-hour (kWh) at a first time, and an estimate of the electrical load or a second energy/power consumption value of that device at a second time may be 0.1 kWh when it is turned on. In another example, a current electrical load (or first energy/power consumption value) of multiple devices operating in a certain mode when autonomous driving related computations are not performed may be 0.5 kWh (which may include a device operating at 0 kWh), and an estimate of the electrical load or a second energy/power consumption value of the multiple device (and/or additional devices) at a second time may be 1.5 kWh in an autonomous mode when autonomous driving related computations are performed. The estimate of the electrical load of the one or more devices can be a same value as or may indicate the second energy/power consumption value. In some embodiments, the estimate of electrical load can be quantified using a unit of energy such as kilowatt-hour (kWh). In some embodiments, the estimate of the electrical load of multiple devices may be a total estimate of the electrical load of the multiple devices.

One of the technical benefits of the disclosed technology is that the electrical power control module 165 can proactively determine an estimate of the electrical load at the first time so that, as further explained below, an alternator 204 that is mechanically coupled to the propulsion apparatus 208 can generate an electrical output that is approximately the same as the estimate of the electrical load at the second time when the propulsion apparatus 208 increases or decreases its torque or power output or RPM in response to the estimate of the electrical load. In some embodiments, the electrical output of the alternator 204 can be considered to be approximately the same as the estimate of the electrical load when the electrical output of the alternator 204 is within a pre-determined percentage of the estimate of the electrical load.

In some embodiments, the electrical power control module 165 can determine a total estimate of electrical load of multiple devices before the devices consume electrical energy that is same as or close to (e.g., within a certain percentage of) the estimate of the electrical load. For example, when a vehicle is not operating in an autonomous mode, some of the sensors (e.g., cameras, LiDARs, and/or RADARs) or other devices may not operate or may not perform certain computational operations. In this example, when the driving operation module 168 of the in-vehicle control computer 150 receives an indication (e.g., via a graphical use interface (GUI) of a display in the vehicle or via a button in the vehicle) that a person wants to operate the vehicle in an autonomous mode, the driving operation module 168 can send an indication to the electrical power control module 165 that autonomous mode is selected. In this example, when the electrical power control module 165 receives the indication that the autonomous mode is selected, the electrical power control module 165 can obtain a pre-determined estimate of the total electrical load of the devices configured to operate in the autonomous mode. In some embodiments, the vehicle is not operating in an autonomous mode when the driving operation module 168 of the in-vehicle control computer does not send instructions to one or more devices on the vehicle that causes the vehicle to perform autonomous driving related operations (e.g., apply brakes, steer vehicle, select gear, etc.). In some embodiments, the vehicle is operating in an autonomous mode when the driving operation module 168 of the in-vehicle control computer sends instructions to one or more devices on the vehicle that causes the vehicle to perform autonomous driving related operations.

In some embodiments, the electrical power control module 165 can determine an estimate of electrical load of a device or a system of devices before the device or the system consume electrical energy that is same as or close to (e.g., within a certain percentage of) the estimate of the electrical load. For example, when the electrical power control module 165 receives an indication that one of the sensors (e.g., LiDAR) is to be turned on, the electrical power control module 165 can obtain a pre-determined estimate of the electrical load of the device or the system of devices. In some embodiments, the electrical power control module 165 can refer to a look-up table to obtain an estimate of the electrical loads of one or more devices before the one or more devices consume electrical energy that is same as or close to the estimate of the electrical load. In some embodiments, the table may have multiple rows where each row has a set of one or more pre-determined devices and their corresponding estimate of the electrical load when operating in certain mode (e.g., in an autonomous mode when autonomous driving operations are performed).

The in-vehicle control computer 150 may be communicably coupled to an engine/motor control module 206, and the engine/motor control module 206 is communicably coupled to the propulsion apparatus 208. After the electrical power control module 165 determines an estimate of the electrical load of the one or more devices, the electrical power control module 165 can send an electrical load request message 212 to the engine/motor control module 206. The electrical load request message 212 may include a value corresponding to or same as the estimate of the electrical load. The electrical power control module 165 sending an electrical load request message 212 to the engine/motor control module 206 can be considered a feed-forward technique where a request for a certain estimate of the electrical load is indicated, and where the estimate of the electrical load is not based on a torque output or power output or RPM output generated by the propulsion apparatus 208 at the first time when the estimate of the electrical load is determined. In some embodiments, the electrical power control module 165 can send a drive torque or power request message 214 to the engine/motor control module 206, where the drive torque or power request message 214 may include a value corresponding to or same as a torque or power output or RPM requested from the propulsion apparatus 208.

The engine/motor control module 206 receives the estimate of the electrical load from the electrical power control module 165, and the engine/motor control module 206 can convert the estimate of the electrical load to a reference value. The reference value can indicate a torque value or a power output value or an RPM value that the propulsion apparatus 208 can use to increase or decrease a torque or power output or RPM of the propulsion apparatus 208. The engine/motor control module 206 sends the reference value to the propulsion apparatus 208 at a third time which may be in between the first time when the estimate of the electrical load is determined and the second time when the plurality of devices are expected to operate at or close to the estimate of the electrical load. The propulsion apparatus 208 includes a sensor that can measure an output value (e.g., an output torque or the power output or the RPM) of the propulsion apparatus. The sensor can provide the measured output value to the engine/motor control module 206 so that the engine/motor control module 206 can determine a difference between the reference value sent at the third time and the measured output value, which can be referred to as an error value. The engine/motor control module 206 can combine the error value with the reference value to obtain a combined value that is sent to the propulsion apparatus 208 at a fourth time in between the first and second times and after the third time.

The propulsion apparatus 208 is mechanically coupled to the drivetrain 210 (e.g., transmission) and to the alternator 204. The propulsion apparatus 208 can generate or produce an output RPM, output torque, or power output so that the drivetrain 210 and the alternator 204 can operate. The output generated by the propulsion apparatus 208 can cause the drivetrain 210 to operate which can cause the vehicle to move or to be driven on a road. The output generated by the propulsion apparatus 208 can also cause the alternator to generate electrical power that is related to the estimate of the electrical load that is estimated by the electrical power control module 165 and that indicated to the engine/motor control module by a value in electrical load request 212. The electrical power supply provided by the alternator 204 can be sent to the power distribution system 202 which can then route or send the electrical power supply to one or more devices on or in the vehicle that can use the electrical power supply to operate. The electrical power supply can be increased or decreased based on the value in the electrical load request 212 that indicates the estimate of the electrical load. One of the technical benefits of the technique to indicate the estimate of the electrical load before the device(s) increase or decrease their energy consumption is that the propulsion apparatus 208 can be controlled to output torque or power or RPM that can adequately operate the drivetrain and the alternator to minimize instances where increase or decrease in energy consumption can cause a sudden jerk in the vehicle.

In some embodiments where the propulsion apparatus 208 is an internal combustion engine, the value included in the electrical load request message 212 can be an instantaneous torque value that may change over time based on demand. In some embodiments where the propulsion apparatus 208 is an electric motor, the value included in the electrical load request message 212 can be an instantaneous power or current value that may change over time based on demand. For example, after the electrical power control module 165 sends the second energy or power consumption value to the engine/motor control module 206, the electrical power control module 165 can send a third energy or power consumption value that is less than the second energy or power consumption value. The propulsion apparatus 208 can generate another output (e.g., another power or another output torque or another output RPM) that is based on the third energy or power consumption value, and another electrical output generated by the alternator 204 is approximately same as (e.g., within a pre-determined percentage of) the third energy or power consumption value.

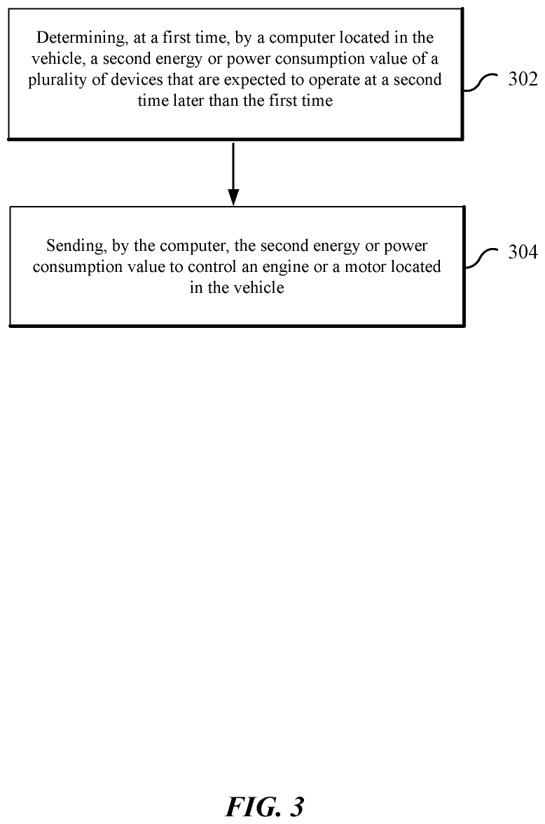

FIG. 3 shows an example flowchart for controlling a propulsion apparatus of a vehicle based on an estimate of the electrical load of one or more devices on or in the vehicle. Operation 302 includes determining, at a first time, by a computer located in the vehicle, a second energy or power consumption value of a plurality of devices that are expected to operate at a second time later than the first time, where the second energy or power consumption value is a different than a first energy or power consumption value of the plurality of devices at the first time, where the second energy or power consumption value is an estimate of an electrical load of the plurality of devices at the second time, and where the plurality of devices are located on or in the vehicle. Operation 304 includes sending, by the computer, the second energy or power consumption value to control an engine or a motor located in the vehicle, where the sending the second energy or power consumption value causes the engine or the motor to generate an output (e.g., output power or an output torque or an output revolutions per minute (RPM)) that is based on the second energy or power consumption value, and where an electrical output generated by an alternator that is mechanically coupled to the engine or the motor is approximately same as the second energy or power consumption value.

In some embodiments, the second energy or power consumption value of the plurality of devices is determined based on the computer receiving an indication that indicates that the vehicle is expected to perform autonomous driving related operations. In some embodiments, the autonomous driving related operations include sending instructions to one or more devices in the vehicle, where the instructions cause the one or more devices to steer or apply brakes or select a gear for the vehicle. In some embodiments, an energy or power consumption value of a device of the plurality of devices at the first time is zero kilowatt-hour (kWh), and the first energy or power consumption value includes the energy or power consumption value added to one or more additional energy or power consumption values of one or more additional energy or power consumption values.

In some embodiments, the electrical output is approximately the same as the second energy or power consumption value in response to the electrical output being within a pre-determined percentage of the second energy or power consumption value. In some embodiments, the determining the second energy or power consumption value of the plurality of devices includes determining at the first time a first estimate of a first electrical load of a device that is expected to be turned on at the second time, where the plurality of devices include the device. In some embodiments, the first energy or power consumption value is lower than the second energy or power consumption value. In some embodiments, the second energy or power consumption value is not based on another output (e.g., another output power or another output torque or another output RPM) generated by the engine or the motor at the first time.

In some embodiments, the first energy or power consumption value and the second energy or power consumption value indicate values having units of energy of kilo-watt hour (kWh). In some embodiments, after the sending the second energy or power consumption value, the operations further comprise: sending a third energy or power consumption value that is less than the second energy or power consumption value to control the engine or the motor, where the sending the third energy or power consumption value causes the engine or the motor to generate another output (e.g., another output power or another output torque or another output RPM) that is based on the third energy or power consumption value, and where another electrical output generated by the alternator is approximately same as the third energy or power consumption value. In some embodiments, the second energy or power consumption value of the plurality of devices is determined based on a total electrical load of at least some of the plurality of devices for autonomous driving related operations. In some embodiments, the estimate of the electrical load of the plurality of devices at the second time includes a total electrical load of the plurality of devices at the second time.

In some embodiments, a system comprises a computer located in a vehicle, the computer comprising a processor configured to implement a method, comprising: determine, at a first time, a second energy or power consumption value of a plurality of devices that are expected to operate at a second time later than the first time, where the second energy or power consumption value is a different than a first energy or power consumption value of the plurality of devices at the first time, where the second energy or power consumption value is an estimate of an electrical load of the plurality of devices at the second time, and where the plurality of devices are located on or in the vehicle; and send, by the computer, the second energy or power consumption value to control an engine or a motor located in the vehicle, where the send the second energy or power consumption value causes the engine or the motor to generate an output (e.g., an output power or an output torque or an output revolutions per minute (RPM)) that is based on the second energy or power consumption value, and where an electrical output generated by an alternator that is mechanically coupled to the engine or the motor is approximately same as the second energy or power consumption value.

In some embodiments, the system further comprises a device that is communicably coupled to the computer and a propulsion apparatus, where the device includes a microcontroller that is configured to: receives the second energy or power consumption value from the computer; convert the second energy or power consumption value to a first value; and send the first value to the engine or the motor. In some embodiments, the microcontroller of the device is further configured to: receive, from the engine or the motor, a measured value that is a measurement of the output, where the output includes an output power or an output torque or an output revolutions per minute (RPM); determine an error value as a difference between the first value and the measured value; and send a combined value to the engine or the motor, where the combined value is a function of the error value and the first value that is related to the second energy or power consumption value. In some embodiments, the second energy or power consumption value is a pre-determined estimate of the electrical load of the plurality of devices. In some embodiments, the first energy or power consumption value is higher than the second energy or power consumption value. In some embodiments, the plurality of devices include one or more cameras and one or more LiDARs. In some embodiments, the vehicle is a tractor unit of a semi-trailer truck.

Implementations of the subject matter and the functional operations described in this patent document can be implemented in various systems, semiconductor devices, ultrasonic devices, digital electronic circuitry, or in computer software, firmware, or hardware, including the structures disclosed in this specification and their structural equivalents, or in combinations of one or more of them. Implementations of aspects of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of controlling a vehicle, comprising:
determining, at a first time, by a computer located in the vehicle, a second energy or power consumption value of a plurality of devices that are expected to operate at a second time later than the first time,
wherein the second energy or power consumption value is a different than a first energy or power consumption value of the plurality of devices at the first time,
wherein the second energy or power consumption value is an estimate of an electrical load of the plurality of devices at the second time, and
wherein the plurality of devices are located on or in the vehicle; and
sending, by the computer, the second energy or power consumption value to control an engine or a motor located in the vehicle,
wherein the sending the second energy or power consumption value causes the engine or the motor to generate an output that is based on the second energy or power consumption value, and
wherein an electrical output generated by an alternator that is mechanically coupled to the engine or the motor is approximately same as the second energy or power consumption value.

2. The method of claim 1, wherein the second energy or power consumption value of the plurality of devices is determined based on the computer receiving an indication that indicates that the vehicle is expected to perform autonomous driving related operations.

3. The method of claim 2, wherein the autonomous driving related operations include sending instructions to one or more devices in the vehicle, wherein the instructions cause the one or more devices to steer or apply brakes or select a gear for the vehicle.

4. The method of claim 1,
wherein an energy or power consumption value of a device of the plurality of devices at the first time is zero kilowatt-hour (kWh), and
wherein the first energy or power consumption value includes the energy or power consumption value added to one or more additional energy or power consumption values of one or more additional energy or power consumption values.

5. The method of claim 1, wherein the electrical output is approximately the same as the second energy or power consumption value in response to the electrical output being within a pre-determined percentage of the second energy or power consumption value.

6. A non-transitory computer readable program storage medium having code stored thereon, the code, when executed by a processor, causing the processor to perform operations comprising:
determining, at a first time, by a computer located in a vehicle, a second energy or power consumption value of a plurality of devices that are expected to operate at a second time later than the first time,
wherein the second energy or power consumption value is a different than a first energy or power consumption value of the plurality of devices at the first time,
wherein the second energy or power consumption value is an estimate of an electrical load of the plurality of devices at the second time, and
wherein the plurality of devices are located on or in the vehicle; and
sending, by the computer, the second energy or power consumption value to control an engine or a motor located in the vehicle,
wherein the sending the second energy or power consumption value causes the engine or the motor to generate an output that is based on the second energy or power consumption value, and
wherein an electrical output generated by an alternator that is mechanically coupled to the engine or the motor is approximately same as the second energy or power consumption value.

7. The non-transitory computer readable program storage medium of claim 6, wherein the determining the second energy or power consumption value of the plurality of devices includes determining at the first time a first estimate of a first electrical load of a device that is expected to be turned on at the second time, wherein the plurality of devices include the device.

8. The non-transitory computer readable program storage medium of claim 6, wherein the first energy or power consumption value is lower than the second energy or power consumption value.

9. The non-transitory computer readable program storage medium of claim 6, wherein the second energy or power consumption value is not based on another output generated by the engine or the motor at the first time.

10. The non-transitory computer readable program storage medium of claim 6, wherein the first energy or power consumption value and the second energy or power consumption value indicate values having units of energy of kilo-watt hour (kWh).

11. The non-transitory computer readable program storage medium of claim 6, wherein after the sending the second energy or power consumption value, the operations further comprise:
sending a third energy or power consumption value that is less than the second energy or power consumption value to control the engine or the motor,
wherein the sending the third energy or power consumption value causes the engine or the motor to generate another output that is based on the third energy or power consumption value, and
wherein another electrical output generated by the alternator is approximately same as the third energy or power consumption value.

12. The non-transitory computer readable program storage medium of claim 6, wherein the second energy or power consumption value of the plurality of devices is determined based on a total electrical load of at least some of the plurality of devices for autonomous driving related operations.

13. The non-transitory computer readable program storage medium of claim 6, wherein the estimate of the electrical load of the plurality of devices at the second time includes a total electrical load of the plurality of devices at the second time.

14. A system, comprising:
a computer located in a vehicle, the computer comprising a processor configured to implement a method, comprising:
determine, at a first time, a second energy or power consumption value of a plurality of devices that are expected to operate at a second time later than the first time,
wherein the second energy or power consumption value is a different than a first energy or power consumption value of the plurality of devices at the first time,
wherein the second energy or power consumption value is an estimate of an electrical load of the plurality of devices at the second time, and
wherein the plurality of devices are located on or in the vehicle; and
send, by the computer, the second energy or power consumption value to control an engine or a motor located in the vehicle,
wherein the send the second energy or power consumption value causes the engine or the motor to generate an output that is based on the second energy or power consumption value, and
wherein an electrical output generated by an alternator that is mechanically coupled to the engine or the motor is approximately same as the second energy or power consumption value.

15. The system of claim 14, further comprising:
a device that is communicably coupled to the computer and a propulsion apparatus, wherein the device includes a microcontroller that is configured to:
receives the second energy or power consumption value from the computer;
convert the second energy or power consumption value to a first value; and
send the first value to the engine or the motor.

16. The system of claim 15, wherein the microcontroller of the device is further configured to:
receive, from the engine or the motor, a measured value that is a measurement of the output, wherein the output includes an output power or an output torque or an output revolutions per minute (RPM);
determine an error value as a difference between the first value and the measured value; and
send a combined value to the engine or the motor, wherein the combined value is a function of the error value and the first value that is related to the second energy or power consumption value.

17. The system of claim 15, wherein the second energy or power consumption value is a pre-determined estimate of the electrical load of the plurality of devices.

18. The system of claim 14, wherein the first energy or power consumption value is higher than the second energy or power consumption value.

19. The system of claim 14, wherein the plurality of devices include one or more cameras and one or more LiDARs.

20. The system of claim 14, wherein the vehicle is a tractor unit of a semi-trailer truck.
